(19) United States
(12) Patent Application Publication
(10) Pub. No.: US 2026/0145555 A1
(43) Pub. Date: May 28, 2026

(54) MULTI-CONFIGURATION ELECTRIC VEHICLE CHARGING ADAPTER

(71) Applicant: Toyota Motor Engineering & Manufacturing North America, Inc., Plano, TX (US)

(72) Inventor: Heraldo Felicio Stefanon, Dexter, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/958,144

(22) Filed: Nov. 25, 2024

(51) Int. Cl. B60L 53/16; B60L 53/10; H01R 29/00

(52) U.S. Cl. CPC B60L 53/16; B60L 53/11; H01R 29/00

(57) ABSTRACT

The present specification describes a charging adapter that is switchable between two configurations. The charging adapter includes a charging station port and a vehicle port. The vehicle port includes 1) a set of alternating current (AC) connectors used during AC charging and 2) a set of direct current (DC) connectors used during DC charging. The charging adapter also includes an input switch to receive selection between AC charging and DC charging. The charging adapter also includes a selector that 1) retracts the set of DC connectors when AC charging is selected and 2) electrically disconnects the set of AC connectors from the charging station port when DC charging is selected.

### TECHNICAL FIELD

The subject matter described herein relates, in general, to electrified vehicle charging and, more particularly, to a charging adapter that selectively connects different adapter connectors to a charging station connector based on a selected charging state (e.g., alternating current (AC) or direct current (DC) charging).

### BACKGROUND

Electrification in vehicles is becoming increasingly popular due to the reduced negative environmental impact of electrified vehicles. There are various types of electrified vehicles. As one example, a battery electric vehicle (BEV) is propelled by electrical power rather than by an internal combustion engine (ICE) coupled with a mechanical drivetrain. Other types of electrified vehicles include battery electrical power for propulsion. A plug-in hybrid electric vehicle (PHEV) is another type of electrified vehicle that is propelled by multiple systems. PHEVs may be propelled by electrical power, ICE coupled with a mechanical drivetrain, or by a combination of these propulsion systems. In either case, BEVs and PHEVs consume electrical power over time, and the battery may drain or lose its capability to provide electrical energy.

Other electrified vehicle types include hybrid vehicles (HV) and fuel cell vehicles (FCV). Unlike BEVs and PHEVs, HVs and FCVs use electrical systems with smaller batteries that manage propulsion and battery state of charge (SOC) in a closed system. Accordingly, BEVs and PHEVs may be plugged into a charging station where the battery is recharged. Specifically, the BEV and PHEV may include a port into which a charging station cable is plugged and through which additional power is provided to its battery electric system.

### SUMMARY

In one embodiment, an example charging adapter improves electrified vehicle charging. The charging adapter includes a charging station port and a vehicle port. The vehicle port includes 1) a set of alternating current (AC) connectors used during AC charging and 2) a set of direct current (DC) connectors used during DC charging. The charging adapter includes an input switch to receive selection between AC charging and DC charging. The charging adapter also includes a selector that 1) retracts the set of DC connectors when AC charging is selected and 2) electrically disconnects the set of AC connectors from the charging station port when DC charging is selected.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 depicts a multi-configuration electrified vehicle charging adapter.

FIGS. 2A-2C depict views of a multi-configuration electrified vehicle charging adapter with a lever-based selector.

FIGS. 3A and 3B depict a cross-sectional side view of a multi-configuration electrified vehicle charging adapter with a gear-based selector.

FIGS. 4A and 4B depict a cross-sectional side view of a multi-configuration electrified vehicle charging adapter with a relay-based selector.

### DETAILED DESCRIPTION

A charging adapter that improves the electrified vehicle charging operation is disclosed herein. As previously described, the amount of electrified vehicles (e.g., BEVs and PHEVs) on the roadways of the globe is on the rise in part due to increased electrified vehicle affordability, a reduced negative impact on the environment as compared to exhaust-producing internal combustion engine (ICE) vehicles, and the increased availability of re-charging infrastructure. That is, over time, the capacity of an electrified vehicle battery is reduced as the electrified vehicle uses the energy. The battery may be recharged by plugging the electrified vehicle into a charging station. Widespread adoption of electrified vehicles may be slow, where charging stations are infrequently dispersed throughout a given region and are difficult to locate.

To recharge an electrified vehicle battery, an operator plugs a cable from an electrified vehicle charging station into a port of the electrified vehicle. Electricity is supplied to the electrified vehicle battery and later used to operate the electrified vehicle. In general, the port of the electrified vehicle includes various pins that interact with associated connectors on the cable connector.

There are various pin/connector configurations for electrified vehicles and associated charging stations. One such configuration is the Society of Automotive Engineers (SAE) J1772 configuration, also referred to as a J plug or a Type 1 connector. The SAE J1772 vehicle connector includes five pins, and the charging cable connector has five connectors. Alternating current (AC) is provided through a first AC pin/connector while a neutral pin/connector completes the AC circuit. The electrified vehicle and charging station share data/information through other connectors and pins to facilitate charging. For example, the electrified vehicle connector may include a protective earth (PE) pin, which ensures the charging process is grounded. The electrified vehicle connector may also include a proximity pilot (PP) pin. Via this communication pin, data/information is shared between the charging station and the electrified vehicle, such as data regarding the charging capabilities of the charging station and the charging process. The electrified vehicle connector may also include a control pilot (CP) pin, which is a bi-directional communication pin that allows the vehicle to send signals to the charging station requesting certain charging currents and voltages. The charging station sends signals to the electrified vehicle, informing the vehicle about the status of the charging process.

Another example is the SAE combined charging system (CCS), which is a variant of the J1772 connector that facilitates direct current (DC) fast charging. In addition to the five pins/connectors described above, an SAE CCS connector includes two additional pins, and the SAE CCS charging station port includes two additional connectors. The two additional pins/connectors are high-current pins/connectors that enable DC charging.

Another example is the North American charging system (NACS) connector. Like the SAE J1772 connector, the NACS includes five pins, albeit in a different layout. The NACS connector includes the PE, PP, and CP pins/connectors as described above and two charging pins/connectors used for both AC and DC charging. In this example, the electrified vehicle considers the separation of AC and DC charging in the vehicle electronics components.

The diversity of charging station/vehicle connector/pin layouts may make it difficult for an electrified vehicle operator to charge their vehicle. For example, a non-NACS electrified vehicle connector is incompatible with an NACS charging station. In this example, the electrified vehicle operator may have to use an adapter with a charging station port configured to one protocol (e.g., the NACS charging protocol) and a vehicle port configured to another (e.g., SAE J1772 or SAE CCS).

However, existing adapters may be inefficient. For example, an electrified vehicle may have a connector capable of charging via AC or DC. As a specific example, an electrified vehicle with an SAE CCS connector may be able to 1) charge the battery through the AC pins of the SAE J1772 portion of the connector via alternating current or 2) charge the battery through the DC pins of the SAE CCS portion of the connector via direct current. That is, an operator may select whether to charge the electrified vehicle battery via AC or DC.

When using a non-SAE charging station (e.g., an NACS charging station), an electrified vehicle operator may need two adapters, an AC charging adapter, and a DC charging adapter to avail themselves of both charging options. That is, an operator with an SAE-based electrified vehicle may need an SAE J1772 adapter for AC charging and an SAE CCE adapter for DC charging.

Accordingly, the present application describes a connector that facilitates AC charging and DC charging modes. The present charging adapter facilitates both AC and DC charging by 1) retracting DC connectors (e.g., SAE CCS connectors) and electrically activating AC connectors (e.g., SAE J1772 AC connectors) during AC charging and 2) electrically disconnecting the AC connectors (e.g., SAE J1772 AC connectors) and extending the DC connectors (e.g., SAE CCS connectors) during DC charging. That is, the charging adapter of the present specification is a universal adapter for electrified vehicles with both SAE J1772 or SAE CCS charge inlets to provide AC or DC power when at an NACS charging station and does so while avoiding the risk of applying the wrong current.

In one example, the internal AC/DC connector switching may be effectuated using a lever-type seesaw selector to 1) move the DC connectors when in AC charging mode and 2) electrically disconnect the AC connectors when in DC charging mode. The charging adapter may include a mechanical dial or other switch that allows the operator to select AC or DC charging. A mechanical switch is coupled to the selector such that when DC charging is selected, the CCS connectors are extended. In contrast, the AC connectors are electrically disconnected from the charging station connectors. When AC charging is selected, the CCS connectors are retracted, while the AC connectors are electrically connected to the charging station connectors. In another example, the selector may be electrical, where switches electronically disconnect or connect sets of connectors based on the selected charging mode.

In this way, the disclosed charging adapter has multiple configurations such that an operator can carry one adapter to facilitate multiple types of SAE/NACS connector conversions. Unused connectors are retracted and/or electrically disconnected to prevent damage to the electrified vehicle and/or harm to the user.

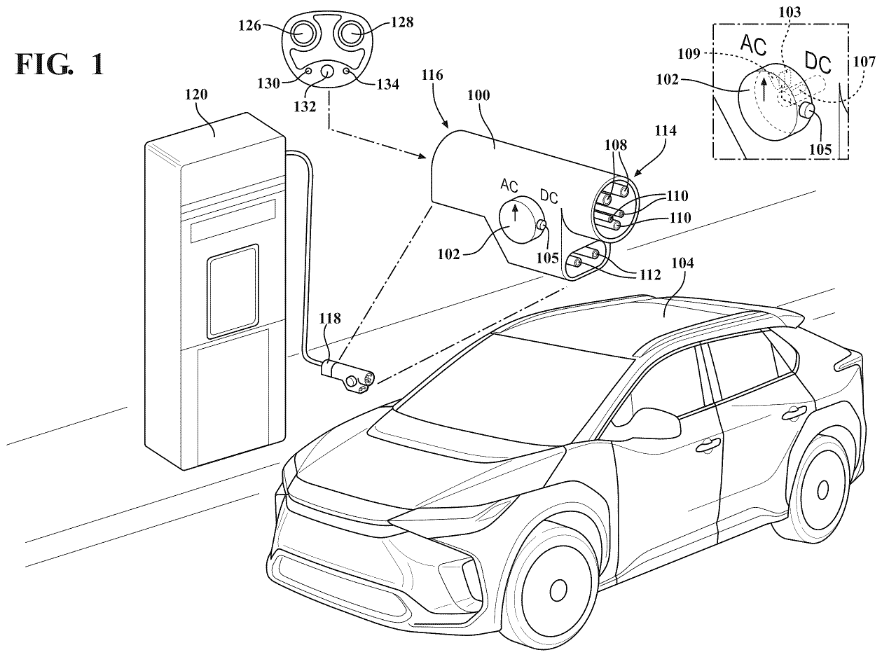

Turning now to the figures, FIG. 1 depicts a multi-configuration electrified vehicle charging adapter 100. As used herein, an “electrified vehicle” is any form of transport that may be motorized or otherwise powered electrically and has a plug, such as a BEV or a PHEV. In one or more implementations, the electrified vehicle is an electrified automobile. While arrangements will be described herein with respect to electrified automobiles, it will be understood that embodiments are not limited to electrified automobiles. In some implementations, the electrified vehicle may be an electrified robotic device or a form of transport that, for example, includes a port to receive electrical operating power from a charging station 120.

Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

As described above, an electrified vehicle 104 (e.g., a BEV or a PHEV) may connect with a charging station 120 to replenish its batteries or other electrical power source. However, as described above, an electrified vehicle 104 may have a charging port with a pin configuration that does not match the connector configuration of the charging station 120 cable. Moreover, as described above, improper current on particular pins (e.g., AC on DC pins or DC on AC pins) of the electrified vehicle 104 may damage the charging station 120 and/or the electrified vehicle and/or may cause harm to the operator. Accordingly, the present specification describes a charging adapter 100 that avoids these and other issues.

In general, the charging adapter 100 includes a charging station port 116. The charging station port 116 is adapted to be inserted into a charging cable 118 of a charging station 120. The charging station charging connectors 126, 128, 130, 132, and 134 of the charging station port 116 may be pin-type connectors that fit into socket-type connectors of the charging cable 118.

The charging adapter 100 also includes a vehicle port 114. As described above, the vehicle port 114 portion of the charging adapter 100 is switchable between different modes. Specifically, the vehicle port 114 has different sets of connectors that are either extendable and retractable or electrically activated/deactivated. Doing so ensures that proper current is passed to particular pins of the electrified vehicle 104 (e.g., DC to DC pins and AC to AC pins).

Specifically, the vehicle port 114 includes a set of AC connectors 108 that are used during AC charging. Specifically, the AC connectors 108 receive AC pins of the electrified vehicle 104. The vehicle port 114 also includes a set of DC connectors 112 used during DC charging. The DC connectors 112 receive DC pins of the electrified vehicle 104. The vehicle port 114 also includes a set of multi-use connectors 110 (e.g., PE connector, PP connector, and CP connector) used during AC charging and DC charging. Each connector may be formed of a conductive material to conduct electricity from the charging station 120 pins to the electrified vehicle 104 pins. In general, the connectors 108, 110, and 112 are socket-type connectors that receive pin-type connectors of an electrified vehicle 104 port.

The connectors on the vehicle side (e.g., connectors 108, 110, and 112) are connected with associated connectors on the charging station side (e.g., connectors 126, 128, 130, 132, and 134). For example, the multi-use connectors 110 (e.g., the PP, PE, and CP connectors) may be paired with the charging station PP connector 130, the charging station PE connector 132, and the charging station CP connector 134, respectively. That is, an electrical connection, such as an electrical wire in the body of the charging adapter 100, may connect these connectors to facilitate data and message transfer. At different points in time, the AC connectors 108 and the DC connectors 112 of the vehicle port 114 may be connected to the charging station charging connectors 126 and 128.

As described above, electrified vehicle 104 damage, charging station 120 damage, and/or operator harm can occur if an incorrect connector arrangement is present on the charging adapter 100. Accordingly, the charging adapter 100 has multiple modes, wherein different connector sets are activated based on a selected charging mode. Specifically, the charging adapter 100 includes an input switch, such as a lockable dial 102, that receives a selection between AC charging and DC charging. In the example depicted in FIG. 1, the input switch is a dial 102 rotatable between an “AC” position and a “DC” position. In an example, the dial 102 is lockable such that the connectors/sleeves remain in place (e.g., extended or retracted) during charging. For example, the lockable dial 102 may include a button 105, which retracts a protrusion 103 on the adapter-facing side of the lockable dial 102. When in the “AC” position, the protrusion 103 sits in an AC recess 109. When in the “DC” position, the protrusion 103 sits in a DC recess 107. The interface between the protrusion 103 and the recess 107 and 109 in which it sits prevents the undesired rotation of the lockable dial 102 and the undesired movement of the respective components of the selector. While FIG. 1 depicts a particular type of input switch, other input switches may exist. For example, the input switch may be a slider that translates back and forth. Moreover, the charging adapter 100 may include other lockable input switches.

The input switch is coupled, either mechanically or electrically, to a selector that 1) retracts the set of DC connectors 112 when AC charging is selected and 2) electrically disconnects the set of AC connectors 108 from the charging station port 116 when DC charging is selected. The DC connectors 112 are physically retracted to 1) prevent DC from being transmitted to the electrified vehicle 104 via these connectors and 2) facilitate the physical connection of the vehicle port 114 to a non-CCS type SAE charger. That is, the electrified vehicle 104 may include the 5-pin SAE J1772 connector with no DC CCS pins. In this example, the physical presence of the DC connectors 112 and the housing surrounding the DC connectors 112 on a charging adapter 100 may prevent the vehicle port 114 from being inserted into the electrified vehicle 104 port because of the additional DC connectors 112. By retracting the DC connectors 112 and the surrounding housing, the vehicle port 114 becomes connectable to an AC-only electrified vehicle 104 port.

By comparison, instead of being physically retracted, the AC connectors 108 may be electrically disconnected from the charging station charging connectors 126 and 128 of the charging station port 116. That is, during DC charging, the AC connectors 108 are disconnected and unused. In DC-only adapters, these AC connectors 108 may not be present. However, removing these AC connectors 108 from the presently described charging adapter 100 prevents the charging adapter 100 from being able to provide AC charging. Accordingly, the charging adapter 100 of the present specification includes AC connectors 108, thus providing AC charging capability, but retracts the AC connectors 108 during DC charging.

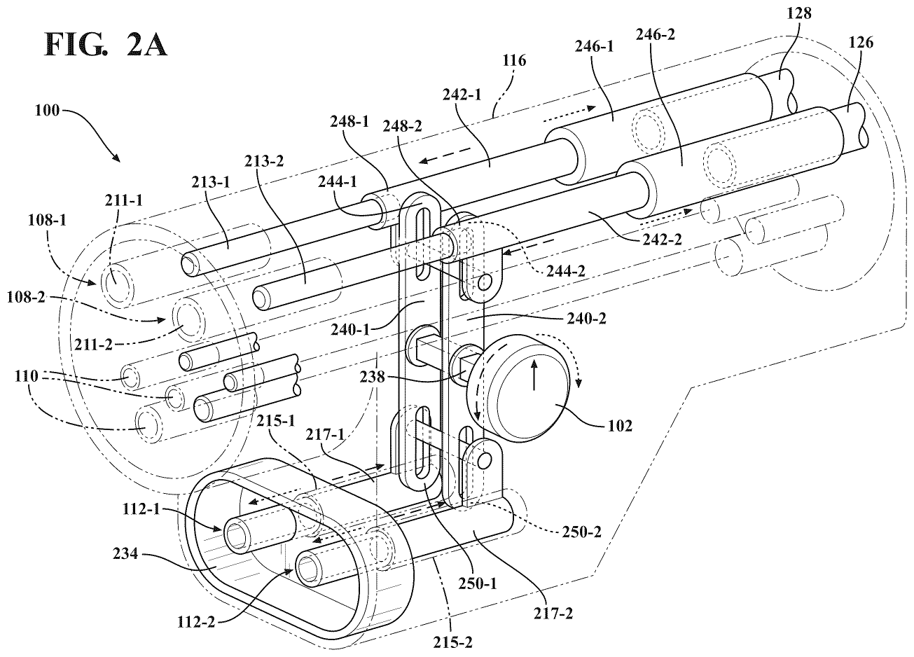

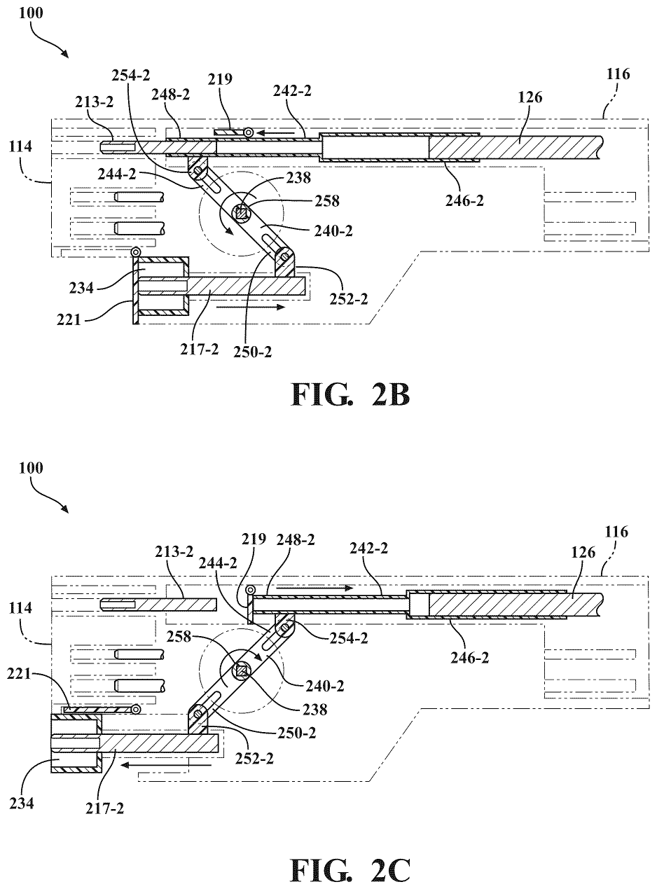

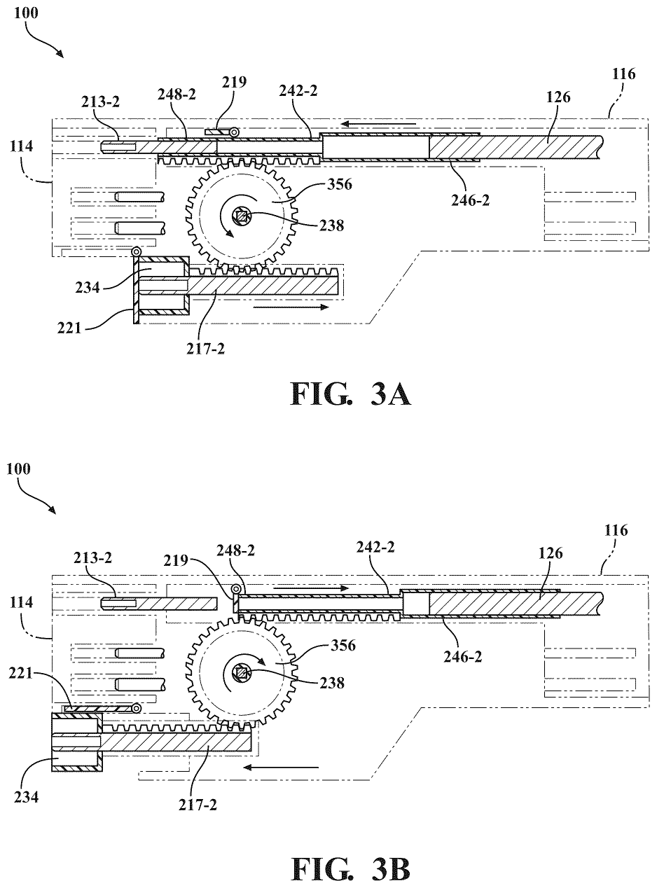

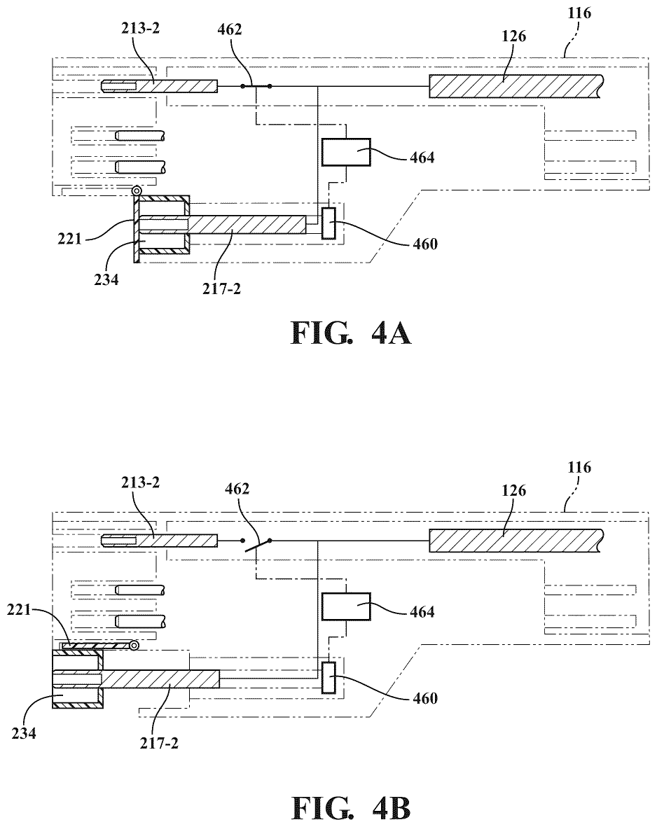

The selector may take a variety of forms. For example, FIGS. 2A-2C depict a lever-based selector, FIGS. 3A and 3B depict a gear-based selector, and FIGS. 4A and 4B depict a magnet-based selector.

FIGS. 2A-2C depict views of the multi-configuration electrified vehicle charging adapter 100 with a lever-based selector. Specifically, FIG. 2A depicts a perspective view of a lever-based selector, FIG. 2B depicts a cross-sectional side view of the lever-based selector in an AC charging mode, and FIG. 2C depicts a cross-sectional side view of the lever-based selector in a DC charging mode.

In general, the lever-based selector operates by simultaneously 1) retracting the DC connectors 112-1 and 112-2 and electrically connecting the AC connectors 108-1 and 108-2 to the respective charging station charging connectors 126 and 128 during AC charging and 2) extending the DC connectors 112-1 and 112-2 and electrically disconnecting the AC connectors 108-1 and 108-2 from the respective charging station charging connectors 126 and 128 during DC charging.

As described above, AC connectors 108-1 and 108-2 include 1) sockets 211-1 and 211-2 that receive vehicle pins and 2) pins 213-1 and 213-2 recessed within each respective socket 211-1 and 211-2 that form an electrical connection with the respective vehicle pins. Similarly, DC connectors 112-1 and 112-2 include 1) sockets 215-1 and 215-2 that receive vehicle pins and 2) pins 217-1 and 217-2 recessed within each respective socket 215-1 and 215-2 that form an electrical connection with the respective vehicle pins.

In an example, the selector includes a switch per group of connectors. That is, a first AC connector 108-1 may be paired with a first DC connector 112-1 and a first charging station charging connector 128, while a second AC connector 108-2 may be paired with a second DC connector 112-2 and a second charging station charging connector 126. The movement of the multiple switches is synchronized such that both AC connectors 108-1 and 108-2 are electrically disconnected/connected simultaneously, and respective DC connectors 112-1 and 112-2 are extended/retracted simultaneously.

In this example, the input switch may include a lockable dial 102 formed on the charging adapter 100 housing. The lockable dial 102 is rotatable between an “AC” position and a “DC” position. When the lockable dial 102 is set in the AC position, the AC connectors 108-1 and 108-2 are in electrical communication with the charging station charging connectors 126 and 128, while the DC connectors 112-1 and 112-2 and the housing 234 that surrounds them, is retracted into the body of the charging adapter 100 in a disengaged position as depicted in FIG. 2B. When the lockable dial 102 is set in the DC position, the AC connectors 108-1 and 108-2 are electrically disconnected from the charging station charging connectors 126 and 128, while the DC connectors 112-1 and 112-2 and the housing 234 that surrounds them, is extended from the body of the charging adapter 100 in an engaged position as depicted in FIG. 2B. As described above, the dial 102 may be lockable via a protrusion 103 and recess 107/109 interaction.

In this example, a dial shaft 238 (which may be non-conductive or placed within a non-conductive portion of a shaft) is connected to and rotatable with the lockable dial 102. That is, the dial shaft 238 may extend from the center of one surface of the lockable dial 102 through the body of the charging adapter 100. In an example, the dial shaft 238 and the lockable dial 102 may be integrally formed. That is, the lockable dial 102 and the dial shaft 238 may be formed of a single body, which body may be of a conductive material such as a metallic material. In the example where the lockable dial 102 and dial shaft 238 are formed of a conductive material, the respective switch shaft 240 may include a non-conductive isolation material lining as described below. In another example, the lockable dial 102 and the dial shaft 238 may be formed of a non-conductive material.

As described above, the selector, which is connected to and rotatable with the dial shaft 238, includes a mechanical switch per connector group to selectively activate the connectors of the connector group based on a selected charging state. For example, a first mechanical switch may selectively activate/deactivate the first DC connector 112-1 and the first AC connector 108-1 (i.e., retract/extend the first DC connector 112-1 and electrically activate/deactivate the first AC connector 108-1) while a second mechanical switch may selectively activate/deactivate the second DC connector 112-2 and the second AC connector 108-2 (i.e., retract/extend the second DC connector 112-2 and electrically activate/deactivate the second AC connector 108-2).

In this example, each mechanical switch includes a switch shaft 240-1 and 240-2 affixed to the dial shaft 238 and extending perpendicular from the dial shaft 238 in two directions. From the perspective of FIGS. 2A-2C , the first ends 244-1 and 244-2 of the switch shafts 240-1 and 240-2 extend upward from the dial shaft 238, while the second ends 250-1 and 250-2 of the switch shafts 240-1 and 240-2 extend downward from the dial shaft 238. The effect is that the dial shaft 238 rotation translates the ends of the switch shafts 240-1 and 240-2 in different directions. That is, rotation of the lockable dial 102 and dial shaft 238 in a clockwise direction may translate first ends 244-1 and 244-2 of the switch shafts 240-1 and 240-2 in a first horizontal direction (e.g., a rightward direction) while the second ends 250-1 and 250-2 of the switch shafts 240-1 and 240-2 translate in a second horizontal direction (e.g., a leftward direction) that is opposite the first horizontal direction. The short dashed arrows indicate this coordinated motion. Similarly, rotation of the lockable dial 102 and dial shaft 238 in a counterclockwise direction may translate first ends 244-1 and 244-2 of the switch shafts 240-1 and 240-2 in the second horizontal direction (e.g., the leftward direction) while the second ends 250-1 and 250-2 of the switch shafts 240-1 and 240-2 translate in the first horizontal direction (e.g., the rightward direction). The long dashed arrows indicate this coordinated motion.

To electrically connect/disconnect the AC connectors 108-1 and 108-2 from the charging station charging connectors 126 and 128, each mechanical switch includes a sleeve 242-1 and 242-2 pivotally coupled to a respective first end 244-1 and 244-2 of the respective switch shaft 240-1 and 240-2. For example, the switch shafts 240-1 and 240-2 may include an aperture in the respective first ends 244-1 and 244-2. In an example, the aperture in the respective first ends 244-1 and 244-2 may be elongated or ovular so that a pin may slide within the aperture. This elongated aperture ensures that the sleeves 242-1 and 242-2 translate horizontally as the first ends 244-1 and 244-2 follow a curved arc path when rotated.

A protrusion extending from each sleeve 242-1 and 242-2 may similarly include an aperture. A pin is positioned through these apertures such that the translational motion of the first ends 244-1 and 244-2 is converted to translational motion of the respective sleeves 242-1 and 242-2. Accordingly, rotation of the lockable dial 102 in a clockwise direction may translate the sleeves 242-1 and 242-2 in the first horizontal direction (e.g., the rightward direction), as indicated by the short dashed arrows. Similarly, rotation of the lockable dial 102 in a counterclockwise direction may translate the sleeves 242-1 and 242-2 in the second horizontal direction (e.g., the leftward direction), as indicated by the long dashed arrows. Note that in these examples, the sleeves 242-1 and 242-2 may be positioned within horizontal channels formed in the body of the charging adapter 100 to facilitate the translational movement of the sleeves 242-1 and 242-2.

In general, the sleeves 242-1 and 242-2 are formed of a conductive material such as aluminum. The sleeves 242-1 and 242-2 surround and are in contact with the respective connectors (e.g., the charging station charging connectors 126 and 128 and the AC connector pins 213-1 and 213-2). In an example, the sleeves 242-1 and 242-2 may include inwardly-directed protrusions that are also metallic that contact the surface of the respective AC connector pins 213-1 and 213-2 and charging station charging connectors 126 and 128 but do not prevent translational motion. In another example, the inside diameter of the sleeves 242-1 and 242-2 may generally match the outside diameter of the respective connectors, as depicted in FIGS. 2B and 2C to contact the sidewalls of the respective connectors (e.g., the charging station charging connectors 126 and 128 and the AC connector pins 213-1 and 213-2) but slide translationally relative to such. That is, the sleeves 242-1 and 242-2 may be in slidable electrical contact with the respective connectors. While particular reference is made to particular types of slideable electrical connections, other arrangements may be implemented in accordance with the principles described herein.

Each sleeve 242-1 and 242-2 may include a charging station end portion 246-1 and 246-2 that surrounds a respective charging station charging connector 126 and 128 of the connector group. Specifically, a first charging station end portion 246-1 of a first sleeve 242-1 may surround a first charging station charging connector 128 of a first connector group while a second charging station end portion 246-2 of a second sleeve 242-2 may surround a second charging station charging connector 126 of a second connector group.

Similarly, each sleeve 242-1 and 242-2 may include an AC end portion 248-1 and 248-2 that surrounds an AC pin 213-1 and 213-2 of the connector group. Specifically, a first AC end portion 248-1 of the first sleeve 242-1 may surround a first AC connector pin 213-1 of the first connector group, while a second AC end portion 248-2 of the second sleeve 242-2 may surround a second AC connector pin 213-2 of the second connector group. In an example, the different end portions have different diameters to facilitate the differently sized respective pins. As described above, in this example, the AC connectors 108-1 and 108-2 and the charging station charging connectors 126 and 128 do not translate and are positionally fixed within the charging adapter 100, rather the sleeves 242-1 and 242-2 translate as depicted in FIGS. 2B and 2C.

In contrast, to electrically connect/disconnect the DC connectors 112-1 and 112-2 from the charging station charging connectors 126 and 128, the DC connectors 112-1 and 112-2 of the connector group are perpendicular and pivotally coupled to a second end 250-1 and 250-2 of the respective switch shafts 240-1 and 240-2 such that rotation of the lockable dial 102 translates the DC connectors 112-1 and 112-2. That is, rather than electrically de-activating connectors via a sliding sleeve as is the case with the AC charging components, the mechanical switch physically retracts the DC connectors 112-1 and 112-2 (i.e., respective sockets 215-1 and 215-2 and DC connector pins 217-1 and 217-2), and the housing 234 that surrounds the DC connectors 112-1 and 112-2.

The DC connectors 112-1 and 112-2 are pivotally coupled to a second end 250-1 and 250-2 of the respective switch shafts 240-1 and 240-2. For example, the switch shafts 240-1 and 240-2 may include an aperture in the respective second ends 250-1 and 250-2. In an example, the aperture in the respective second ends 250-1 and 250-2 may be elongated or ovular so that the pin may slide within the aperture. This elongated aperture ensures that the DC connectors 112-1 and 112-2 translate horizontally as the second ends 250-1 and 250-2 follow a curved arc path when rotated.

A protrusion extending from each DC connector pin 217-1 and 217-2 may similarly include an aperture. A pin is positioned through these apertures such that the translational motion of the second ends 250-1 and 250-2 is converted to translational motion of the DC connectors 112-1 and 112-2. Accordingly, rotation of the lockable dial 102 in a clockwise direction may translate the DC connectors 112-1 and 112-2 in the second horizontal direction (e.g., the leftward direction as indicated by the short dashed arrows), which second horizontal direction is opposite the first horizontal direction (e.g., the rightward direction) of the sleeves 242-1 and 242-2 when the lockable dial 102 is rotated in the clockwise direction. Similarly, rotation of the lockable dial 102 in a counterclockwise direction may translate the DC connectors 112-1 and 112-2 in the first horizontal direction (e.g., the rightward direction as indicated by the long dashed arrows), which first horizontal direction is opposite the second horizontal direction (e.g., the leftward direction) of the sleeves 242-1 and 242-2 when the lockable dial 102 is rotated in the counterclockwise direction. Note that in these examples, the DC connectors 112-1 and 112-2 may be positioned within horizontal channels of the body of the charging adapter 100 to facilitate the translational movement of the DC connectors 112-1 and 112-2.

As described above, FIG. 2B depicts the charging adapter 100 in an AC charging mode. That is, rotation of the lockable dial 102 (not shown) in a counterclockwise direction (as indicated by the curved arrow) retracts the DC connectors 112-1 (not shown) and 112-2 and the housing 234 that surrounds such within the body of the charging adapter 100. That is, the housing 234 may be rigidly affixed to the DC connectors 112-1 and 112-2 such that the motion of the DC connectors 112-1 and 112-2 defines the motion of the housing 234. Specifically, the set of DC connectors 112-1 and 112-2 is rigidly coupled to a housing 234 that 1) surrounds the set of DC connectors 112-1 and 112-2, 2) is slidable within the body of the charging adapter 100, and 3) is retracted into the body when AC charging is selected. This translational retraction is facilitated by the pivot connection of the second ends 250-1 (not shown) and 250-2 to protrusions 252-2 on the DC connectors 112-1 and 112-2.

Resulting from this same counterclockwise rotation of the lockable dial 102, the sleeves 242-1 (not shown) and 242-2 are translated in the second horizontal direction (e.g., the leftward direction in the frame of view of FIG. 2B). This translational movement of the sleeves 242-1 and 242-2 is facilitated by the pivot connection of the first ends 244-1 (not shown) and 244-2 to protrusions 254-2 on the sleeves 242-1 and 242-2.

Note that when the input switch is in the AC selection position, the sleeves 242-1 and 242-2 surround both the respective charging station charging connectors 126 and 128 (not shown) and the AC connector 108-1 (not shown) and 108-2 of the connector group, thus facilitating an electrical connection between these components.

Moreover, the switch shafts 240-1 (not shown) and 240-2 retract the respective DC connectors 112-1 and 112-2 of the connector group to a disengaged position. When in the disengaged position, the DC connectors 112-1 and 112-2 are retracted sufficiently to 1) not block the insertion of the charging adapter 100 into an AC-only electrified vehicle 104 port and/or 2) not contact the corresponding DC pins of the electrified vehicle 104 port. In this example, the AC flows from the charging station 120 pins through the charging station charging connectors 126 and 128, the sleeves 242-1 and 242-2, the AC connector pins 213-1 and 213-2, and to the electrified vehicle 104 connector AC pins. In this example, AC may also flow to the DC connectors 112-1 and 112-2. However, AC does not flow to the electrified vehicle 104 connector DC pins due to the physical retraction of the DC connectors 112-1 and 112-2.

In an example, the charging adapter 100 may include one or more hinged doors to cover unused connectors of the charging adapter 100. Specifically, as depicted in FIG. 2B, a hinged DC door 221 may cover both the DC connectors 112-1 and 112-2 when the selector is in the AC selection position. The hinged DC door 221 may be spring-loaded and biased to a closed position such that upon retraction of the DC connectors 112-1 and 112-2 and housing 234, the hinged DC door 221 falls to a closed position as depicted in FIG. 2B. The hinged DC door 221 may prevent any dust, debris, or other contaminant from entering the DC connector portion of the charging adapter 100 and may also protect a user from exposure to electricity, which may be present on the DC connectors 112-1 and 112-2.

The charging adapter 100 may also include a hinged sleeve door 219 per sleeve 242 to cover an AC end portion 248 of a sleeve 242 when the selector is in the DC selection position. As with the hinged DC door 221, the hinged sleeve door(s) 219 may be spring-loaded and biased towards a closed position. However, upon extension of the sleeves 242-1 and 242-2, the respective hinged sleeve door(s) 219 may be forced open, as depicted in FIG. 2B. When opened, the hinged sleeve door(s) 219 sit within a recess in a channel where the respective sleeve 242-1 and 242-2 translates.

As described above, FIG. 2C depicts the charging adapter 100 in a DC charging configuration. That is, the rotation of the lockable dial 102 (not shown) in a clockwise direction extends the DC connectors 112-1 (not shown) and 112-2 and the housing 234 that surrounds such from the body of the charging adapter 100. This translational extension is facilitated by the pivot connection of the second ends 250-1 (not shown) and 250-2 to protrusions 252-1 (not shown) and 252-2 on the DC connectors 112-1 and 112-2.

Resulting from this same clockwise rotation of the dial 102, the sleeves 242-1 (not shown) and 242-2 are translated in the first horizontal direction (e.g., the rightward direction in the frame of view of FIG. 2B) within channels of the body. This translational movement is facilitated by the pivot connection of the first ends 244-1 (not shown) and 244-2 to protrusions 254-2 on the sleeves 242-1 and 242-2.

Note that when the input switch is in the DC selection position, the sleeves 242-1 and 242-2 surround the respective charging station charging connectors 126 and 128 (not shown) of the connector group but not the respective AC connector pins 213-1 (not shown) and 213-2 of the connector group, thus electrically disconnecting the AC connectors 108-1 and 108-2 from the current passing through the charging station charging connectors 126 and 128. That is, the sleeves 242-1 and 242-2 are disconnected from the respective AC connectors 108-1 and 108-2 of the connector group. The gap between the sleeves 242-1 and 242-2 and the respective AC connectors 108-1 and 108-2 may be sufficiently large to prevent arcing between the sleeves 242-1 and 242-2 and the respective AC connectors 108-1 and 108-2. Moreover, the hinged sleeve door(s) 219 may further prevent arcing.

Accordingly, the sleeves 242-1 and 242-2 are sized such that when the lockable dial 102 is in the DC selection position, 1) the respective charging station end portions 246-1 (not shown) and 246-2 surround the respective charging station charging connectors 126 and 128 and 2) the respective AC end portions 248-1 (not shown) and 248-2 surround the respective AC connector pins 213-1 and 213-2. But when the lockable dial 102 is in the AC selection position, 1) the respective charging station end portions 246-1 and 246-2 surround the respective charging station charging connectors 126 and 128 and 2) the respective AC end portions 248-1 and 248-2 are separated from the respective AC connector pins 213-1 and 213-2.

As depicted in FIG. 2C, upon extension of the DC connector pins 217-1 and 217-2, DC sockets 215-1 and 215-2, and housing 234, the hinged DC door 221 may be forced open. When opened, the hinged DC door 221 sits within a recess in the body of the charging adapter 100. As described above, the hinged sleeve door(s) 219 may be spring-loaded and biased to a closed position such that upon retraction of the respective sleeves 242-1 and 242-2, the hinged sleeve door(s) 219 fall to a closed position. The hinged sleeve door(s) 219 may prevent arcing between the sleeves 242-1 and 242-2 and the AC connector pins 213-1 and 213-2.

As described above, the switch shafts 240-1 (not shown) and 240-2 extend the respective DC connectors 112-1 and 112-2 of the connector group to an engaged and locked position, wherein the DC connectors 112-1 and 112-2 are positioned to receive the DC pins of the electrified vehicle 104. In this example, the DC flows from the charging station 120 pins through the charging station charging connectors 126 and 128, the sleeves 242-1 and 242-2, the switch shafts 240-1 and 240-2, and the DC connectors 112-1 and 112-2 to the electrified vehicle 104 DC pins. Note that in these examples, the DC connectors 112-1 and 112-2 may be positioned within horizontal channels formed in the body of the charging adapter 100 to facilitate the generally translational movement of the DC connectors 112-1 and 112-2.

Accordingly, the mechanical switches, in this example the switch shafts 240-1 and 240-2, may be formed of a conductive material to facilitate this electrical current circuit. However, for user safety, the dial shaft 238 and the lockable dial 102 may be electrically insulated from this current. For example, the dial shaft 238 may be made of a non-conductive material. Accordingly, any current traveling through the switch shaft 240-1 and 240-2 would not pass to the user via the dial shaft 238 and lockable dial 102. In this example, the mechanical selector (e.g., the switch shaft 240-1 and 240-2) may include an aperture through which the dial shaft 238 passes. As depicted in FIGS. 2B and 2C, the aperture may have a square cross-sectional shape in which a square-shaped dial shaft 238 is situated.

In another example, the dial shaft 238 may also be metallic, providing increased mechanical strength over a plastic dial shaft 238. That is, the metallic dial shaft 238 may be more robust against the twisting force that causes the sleeves 242-1 and 242-2 and DC connectors 112-1 and 112-2 to translate. In this example, a central portion of the mechanical selector (e.g., the switch shaft 240-1 and 240-2 in the example depicted in FIGS. 2A-2C) may include a non-conductive central portion 258, which provides electrical insulation to the metallic dial shaft 238 from the metallic current-carrying switch shaft 240-1 and 240-2.

Accordingly, the lever-based selector simultaneously moves two sleeves 242-1 and 242-2 and two DC connectors 112-1 and 112-2 in opposite directions to facilitate multi-mode charging. As such, an electrified vehicle 104 operator may not need two separate adapters but may instead use the single multi-configuration charging adapter 100 described herein in different selectable modes. Such a system also prevents electrified vehicle 104 damage by controlling the current flow to the electrified vehicle 104.

FIGS. 3A and 3B depict a side view of the multi-configuration electrified vehicle charging adapter 100 with a gear-based selector. That is, as described above, the selector may take various forms. In the example depicted in FIGS. 2A-2C , the selector was a lever-based selector where a switch shaft 240 provided the counter-translational movement of the sleeves 242-1 and 242-2 and the DC connectors 112-1 and 112-2. In the example depicted in FIGS. 3A and 3B, a toothed gear 356 and matching toothed sleeves provide the counter-translational motion. That is, the toothed gear 356 operates by simultaneously 1) retracting the DC connectors 112-1 (not shown) and 112-2 and electrically connecting the AC connectors 108-1 (not shown) and 108-2 to the respective charging station charging connectors 126 and 128 (not shown) during AC charging and 2) extending the DC connectors 112-1 and 112-2 and electrically disconnecting the AC connectors 108-1 and 108-2 from the respective charging station charging connectors 126 and 128 during DC charging.

In this example, the selector includes a mechanical switch per group of connectors. That is, a first AC connector 108-1 may be paired with a first DC connector 112-1 and a first charging station charging connector 128, while a second AC connector 108-2 may be paired with a second DC connector 112-2 and a second charging station charging connector 126. The movement of the multiple switches is synchronized such that both AC connectors 108-1 and 108-2 are electrically disconnected/connected simultaneously, and respective DC connectors 112-1 and 112-2 are extended/retracted simultaneously.

In this example, the input switch may include a lockable dial 102 formed on the charging adapter 100 housing. The lockable dial 102 is rotatable between an “AC” position and a “DC” position. When the lockable dial 102 is in the AC position, the AC connectors 108-1 and 108-2 are in electrical communication with the charging station charging connectors 126 and 128, while the DC connectors 112-1 and 112-2 and the housing 234 that surrounds them, is retracted into the body of the charging adapter 100 in a disengaged position as depicted in FIG. 3A. When the lockable dial 102 is in the DC position, the AC connectors 108-1 and 108-2 are electrically disconnected from the charging station charging connectors 126 and 128, while the DC connectors 112-1 and 112-2 and the housing 234 that surrounds them, is extended from the body of the charging adapter 100 in an engaged position as depicted in FIG. 3B. As described above, the lockable dial 102 may be lockable via a protrusion 103 and recess 107/109 interaction.

In this example, the dial shaft 238 is connected to and rotatable with the lockable dial 102. That is, the dial shaft 238 may extend from the center of one surface of the lockable dial 102 through the body of the charging adapter 100.

As described above, the selector, which is connected to and rotatable with the dial shaft 238, includes a mechanical switch per connector group to selectively activate the connectors of the connector group based on a selected charging state. For example, a first mechanical switch may selective activate/deactivate the first DC connector 112-1 and the first AC connector 108-1 (i.e., retract/extend the first DC connector 112-1 and electrically activate/deactivate the first AC connector 108-1) while a second mechanical switch may selective activate/deactivate the second DC connector 112-2 and the second AC connector 108-2 (i.e., retract/extend the second DC connector 112-2 and electrically activate/deactivate the second AC connector 108-2).

In the example depicted in FIGS. 3A and 3B, each mechanical switch includes a gear 356 axially fixed to the dial shaft 238. Accordingly, the rotation of the lockable dial 102 in one direction rotates the gear 356 in the same direction. The gear 356 includes teeth that enmesh with teeth on the sleeves 242-1 (not shown) and 242-2 and on the DC connectors 112-1 and 112-2. That is, the sleeves 242-1 and 242-2 are tangential to a first surface of a respective gear 356. The sleeves 242-1 and 242-2 include teeth that enmesh with the gear 356. The DC connectors 112-1 and 112-2 are tangential to a second surface of the gear 356, which second surface is opposite to the first surface that the sleeves 242-1 and 242-2 are tangential to. Given that the sleeves 242-1 and 242-2 are on opposite sides of the gear 356 as the DC connectors 112-1 and 112-2, rotation of the gear 356 in one direction translates the sleeves 242-1 and 242-2 and DC connectors 112-1 and 112-2 in opposite directions. For example, as the lockable dial 102, dial shaft 238, and gear 356 are rotated counterclockwise, as indicated in FIG. 3A, the teeth of the gear 356 interface with the teeth of the sleeves 242-1 and 242-2 to translate the sleeves 242-1 and 242-2 in the second horizontal direction (e.g., the leftward direction). Via this same counterclockwise rotation, the teeth of the gear 356 interface with the teeth of the DC connectors 112-1 and 112-2 to translate the DC connectors 112-1 and 112-2 in the first horizontal direction (e.g., the rightward direction) to the disengaged position. The solid arrows indicate this coordinated movement. Note that as described above, when the lockable dial 102 is in the AC selection position, the sleeves 242-1 and 242-2 surround both the respective charging station charging connectors 126 and 128 and the respective AC connector pins 213-1 (not shown) and 213-2 of the connector group, thus facilitating an electrical connection between these components.

In this example, the AC flows from the charging station 120 pins through the charging station charging connectors 126 and 128, the sleeves 242-1 and 242-2, the AC connector pins 213-1 (not shown) and 213-2, and to the electrified vehicle 104 connector AC pins. In this example, AC may also flow to the DC connectors 112-1 and 112-2. However, AC does not flow to the electrified vehicle 104 connector DC pins due to the physical retraction of the DC connectors 112-1 and 112-2.

By comparison, as the lockable dial 102, dial shaft 238, and gear 356 are rotated clockwise, as indicated in FIG. 3B, the teeth of the gear 356 interface with the teeth of the sleeves 242-1 and 242-2 to translate the sleeves 242-1 and 242-2 in the first horizontal direction (e.g., the rightward direction). Via this same clockwise rotation, the teeth of the gear 356 interface with the teeth of the DC connectors 112-1 and 112-2 to translate the DC connectors 112-1 and 112-2 in the second horizontal direction (e.g., the leftward direction) to an engaged position. The solid arrows indicate this coordinated movement.

Note that when the input switch is in the DC selection position, the sleeves 242-1 and 242-2 surround the respective charging station charging connectors 126 and 128 of the connector group but not the respective AC connector pins 213-1 and 213-2 of the connector group, thus electrically disconnecting the AC connectors 108-1 and 108-2 from the current passing through the charging station charging connectors 126 and 128. That is, the sleeves 242-1 and 242-2 are disconnected from the respective AC connectors 108-1 and 108-2 of the connector group. The gap between the sleeves 242-1 and 242-2 and the respective AC connectors 108-1 and 108-2 may be sufficiently large to prevent arcing between the sleeves 242-1 and 242-2 and the respective AC connectors 108-1 and 108-2. Moreover, the hinged sleeve door(s) 219 may further prevent arcing.

In this example, the DC flows from the charging station 120 pins through the charging station charging connectors 126 and 128, the sleeves 242-1 and 242-2, the gear 356, the DC connectors 112-1 and 112-2 to the electrified vehicle 104 connector DC pins.

In an example, the gear 356 is formed out of a conductive material such as aluminum to facilitate this electrical current circuit. However, for user safety, the dial shaft 238 and the lockable dial 102 may be electrically insulated from this current. For example, the dial shaft 238 may be made of a non-conductive material. Accordingly, any current traveling through the conductive gear 356 would not pass to the user via the dial shaft 238 and lockable dial 102. In this example, the mechanical selector (e.g., the gear 356) may include an aperture through which the dial shaft 238 passes. As depicted in FIGS. 3A and 3B, the aperture may have a square cross-sectional shape in which a square-shaped dial shaft 238 is situated.

In another example, the dial shaft 238 may also be metallic, providing increased mechanical strength over a plastic dial shaft 238. That is, the metallic dial shaft 238 may be more robust against the twisting force that causes the sleeves 242-1 and 242-2 and DC connectors 112-1 and 112-2 to translate. In this example, a central portion of the mechanical selector (e.g., the gear 356 in the example depicted in FIGS. 3A and 3B) may include a non-conductive central portion 258 which provides electrical insulation to the metallic dial shaft 238 from the metallic current-carrying gear 356.

In the examples depicted in FIGS. 3A and 3B, the sleeves 242-1 and 242-2 may have similar features as described above, specifically of being formed of a conductive material, surrounding and in slidable electrical contact with the respective connectors (e.g., the charging station charging connectors 126 and 128 and the AC connector pins 213-1 and 213-2) and having charging station end portions 246-1 and 246-2 and AC end portions 248-1 and 248-2 that surround respective connectors (e.g., AC connector pins 213-1 and 213-2 and charging station charging connectors 126 and 128). Moreover, the Sleeves 242-1 and 242-2 may translate, and the respective connectors (e.g., AC connectors 108-1 and 108-2 and charging station charging connectors 126 and 128) that they encompass are stationary.

Similarly, in the examples depicted in FIGS. 3A and 3B, the DC connectors 112-1 and 112-2 may have similar features as described above, specifically being integrated with a housing 234 that slides in and out of the charging adapter 100 housing.

Accordingly, the gear-based selector simultaneously moves two sleeves 242-1 and 242-2 and two DC connectors 112-1 and 112-2 in opposite directions to facilitate multi-mode charging. As such, an electrified vehicle 104 operator may not need two separate adapters but can instead use the single multi-configuration charging adapter 100 described herein in different selectable modes. Such a system also prevents electrified vehicle 104 damage by controlling the current flow to the electrified vehicle 104.

FIGS. 4A and 4B depict a side view of a multi-configuration electrified vehicle charging adapter with a relay-based selector. In this example, the selector includes a switch per connector group that electrically connects connectors of the connector group based on a selected charging state. That is, in this example, the charging adapter 100 may include electrical lines or traces that connect the charging station charging connectors 126 and 128 (not shown) to the AC connector pins 213-1 (not shown) and 213-2 and traces that connect the charging station charging connectors 126 and 128 to the DC connector pins 217-1 (not shown) and 217-2. A switch 462 may be placed along an electrical line between the AC connector pins 213-1 and 213-2 and the respective charging station charging connectors 126 and 128. During AC charging, the switch 462 may close such that AC flows from the AC pins of the charging station 120 through the charging station charging connectors 126 and 128 and the AC connectors 108-1 and 108-2 to the AC pins of the electrified vehicle 104.

In this example, an electromagnet 460 may be used to retract the DC connectors 112-1 and 112-2. That is, as described above, the DC connectors 112-1 and 112-2 may be made of a magnetic conductive material. Accordingly, the electromagnet 460 may be activated when in the AC charging mode to draw the DC connectors 112-1 and 112-2 back, as depicted in FIG. 4A.

To de-activate the AC connectors 108-1 and 108-2 during DC charging, that is to electrically disconnect the AC connectors 108-1 and 108-2 from the respective charging station charging connectors 126 and 128, the switch 462 may be opened as depicted in FIG. 4B to interrupt current flow to the AC connector pins 213-1 and 213-2. In this example, the electromagnet 460 may be used to extend the DC connectors 112-1 and 112-2. That is, as described above, the DC connectors 112-1 and 112-2 may be made of a magnetic conductive material or may include a magnetic conductive component. Accordingly, when in the DC charging mode, the polarity of the electromagnet 460 may be reversed to push the DC connectors 112-1 and 112-2 to a position to receive the DC pins of the electrified vehicle 104, as depicted in FIG. 4B.

As described above, the charging adapter 100 may include a hinged DC door 221 to cover the DC connectors 112-1 and 112-2 when in the AC charging mode.

In this example, the selector may include a controller 464 to 1) open and close the switch 462 and 2) activate and program the polarity of the electromagnet 460 based on a selected charging mode. For example, during AC charging, the controller 464 may activate the electromagnet 460 to draw back the DC connectors 112-1 and 112-2 to a disengaged position and close the switch 462 to provide an electrical path between the charging station charging connectors 126 and 128 and the AC connector pins 213-1 and 213-2. During DC charging, the controller 464 may activate the electromagnet 460 to push the DC connectors 112-1 and 112-2 to an engaged position (i.e., to an opposite polarity from that which draws the DC connectors 112-1 and 112-2 back) and opens the switch 462 to interrupt an electrical path between the charging station charging connectors 126 and 128 and the AC connector pins 213-1 and 213-2.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4B, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A charging adapter, comprising:
a charging station port; and
a vehicle port comprising:
a set of alternating current (AC) connectors used during AC charging; and
a set of direct current (DC) connectors used during DC charging;
an input switch to receive selection between AC charging and DC charging; and
a selector that:
retracts the set of DC connectors when AC charging is selected; and
electrically disconnects the set of AC connectors from the charging station port when DC charging is selected.

2. The charging adapter of claim 1, wherein the vehicle port further comprises a set of multi-use connectors used during AC charging and during DC charging.

3. The charging adapter of claim 1, wherein the set of DC connectors is rigidly coupled to a housing that:
surrounds the set of DC connectors;
is slidable within a body of the charging adapter; and
is retracted into the body when AC charging is selected.

4. The charging adapter of claim 1, wherein:
a first AC connector is grouped with a first DC connector and a first charging station charging connector;
a second AC connector is grouped with a second DC connector and a second charging station charging connector;
the input switch comprises:
a lockable dial rotatable between an AC selection position and a DC selection position; and
a dial shaft connected to and rotatable with the lockable dial; and
the selector, connected to and rotatable with the dial shaft, comprises a mechanical switch per connector group to selectively activate an AC connector or a DC connector of the connector group based on a selected charging state.

5. The charging adapter of claim 4, wherein:
the mechanical switch is formed of a conductive material and includes an aperture through which the dial shaft passes; and
the dial shaft is non-conductive.

6. The charging adapter of claim 4, wherein:
the mechanical switch comprises:
a switch shaft affixed to the dial shaft and extending perpendicular from the dial shaft in two directions;
a sleeve perpendicular and pivotally coupled to a first end of the switch shaft, the sleeve comprising:
a charging station end portion that surrounds a charging station charging connector of the connector group; and
an AC end portion that surrounds an AC connector pin of the connector group; and
the DC connector of the connector group is perpendicular and pivotally coupled to a second end of the switch shaft.

7. The charging adapter of claim 6, wherein when the input switch is in the AC selection position:
the sleeve surrounds both the charging station charging connector and the AC connector pin of the connector group; and
the DC connector of the connector group is retracted in a disengaged position.

8. The charging adapter of claim 6, wherein when the input switch is in the DC selection position:
the sleeve:
surrounds the charging station charging connector of the connector group; and
is disconnected from the AC connector pin of the connector group; and
the DC connector of the connector group is extended to an engaged position.

9. The charging adapter of claim 6, further comprising:
a hinged sleeve door to cover the AC end portion of a sleeve when the selector is in the DC selection position; and
a hinged DC door to cover the DC connector when the selector is in the AC selection position.

10. The charging adapter of claim 4, wherein the mechanical switch comprises:
a gear axially affixed to the dial shaft;
a toothed sleeve, tangential to a first surface of the gear, having teeth that enmesh with the gear, the sleeve comprising:
a charging station end portion that surrounds a charging station charging connector of the connector group; and
an AC end portion that surrounds an AC connector pin of the connector group; and
a toothed DC connector of the connector group, tangential to a second surface of the gear, having teeth that enmesh with the gear.

11. The charging adapter of claim 1, wherein:
a first AC connector is grouped with a first DC connector and a first charging station charging connector;
a second AC connector is grouped with a second DC connector and a second charging station charging connector;
the input switch comprises:
a lockable dial rotatable between an AC selection position and a DC selection position; and
the selector comprises:
a switch per connector group to electrically connect connectors of the connector group based on a selected charging state; and
a magnet to retract a DC connector of a connector group when the input switch is in the AC selection position.
